(19) United States
(12) Patent Application Publication
(10) Pub. No.: US 2025/0055503 A1
(43) Pub. Date: Feb. 13, 2025

(54) PARTIALLY AUTONOMOUS COVERAGE ENHANCING DEVICES

(71) Applicant: Sony Group Corporation, Tokyo (JP)

(72) Inventors: Fredrik RUSEK, Eslöv (SE); Jose FLORDELIS, Lund (SE); Kun ZHAO, Malmö (SE); Erik BENGTSSON, Eslöv (SE); Olof ZANDER, Södra Sandby (SE)

(21) Appl. No.: 18/723,453

(22) PCT Filed: Jan. 5, 2023
(86) PCT No.: PCT/EP2023/050154

§ 371 Date: Jun. 23, 2024

(30) Foreign Application Priority Data
Jan. 10, 2022 (SE) 2250007-8

(51) Int. Cl. H04B 7/04; H04W 16/26

(52) U.S. Cl. CPC H04B 7/04013; H04W 16/26

(57) ABSTRACT

Examples provide a method of operating a CED is provided, wherein the CED provides reconfigurable filters for incident signals received along one or more input spatial directions on a radio channel and transmitted as outgoing signals into one or more output spatial directions, the method comprising: configuring the CED to apply a first filter of the reconfigurable filters for a duration greater or equal than 20 ms; detecting a first received power during application of the first filter; configuring the CED to apply a second filter of the reconfigurable filters for a duration greater or equal than 20 ms.

### TECHNICAL FIELD

Various examples generally relate to communicating between nodes using coverage enhancing devices.

### BACKGROUND

In order to increase a coverage area for wireless communication, it is envisioned to use coverage enhancing devices (CEDs), particularly reconfigurable relaying devices (RRD), more particularly, reconfigurable reflective devices. Reconfigurable reflective devices are sometimes also referred to as reflecting large intelligent surfaces (LISs). Huang, C., Zappone, A., Alexandropoulos, G. C., Debbah, M., & Yuen, C. Large intelligent surfaces for energy efficiency in wireless communication available at arXiv:1810.06934v1

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are reflected can be reconfigured by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system.

An access node (AN) may transmit signals to a wireless communication device (UE) via a CED. The CED may receive the incident signals from an input spatial direction and emit the incident signals in an output spatial direction to the UE. The AN may transmit the signals using a beam directed to the CED. In some scenarios, several CEDs may be used in parallel to transmit the signals from the AN to the UE.

With an increasing number of communication nodes (CN), e.g. UEs and ANs, and CEDs it becomes increasingly difficult to determine optimized propagation paths.

### SUMMARY

Accordingly, there may be a need for an optimized method of operating a CED.

According to a first aspect, a method of operating a CED is provided, wherein the CED provides reconfigurable filters for incident signals received along one or more input spatial directions on a radio channel and transmitted as outgoing signals into one or more output spatial directions, the method comprising: configuring the CED to apply a first filter of the reconfigurable filters for a duration greater or equal than 20 ms; detecting a first received power during application of the first filter; configuring the CED to apply a second filter of the reconfigurable filters for a duration greater or equal than 20 ms.

According to a second aspect, a method of operating a CED is provided, wherein the CED provides reconfigurable filters for incident signals received along one or more input spatial directions on a radio channel and transmitted as outgoing signals into one or more output spatial directions, the method comprising: configuring the CED to apply a first spatial filter of the reconfigurable filters; detecting a first received power during application of the first filter; configuring the CED to apply a second filter of the reconfigurable filters, and detecting a second received power during application of the second filter; and performing a comparison of the detected second received power with a predefined criterion and/or the first received power, depending on a result of the comparison: adding an indicator relating to the second filter to a filter database.

According to a third aspect, a CED is provided comprising first antenna elements providing reconfigurable filters adapted for receiving incident signals along one or more spatial directions on a radio channel and transmitting the incident signals into one or more output spatial directions; and a detector for detecting a received power upon application of at least one of the filters.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates a CED towards which one of the multiple transmit beams is directed according to various examples.

FIG. 4 schematically illustrates details with respect to a CED.

FIG. 5 schematically illustrates a scenario benefitting from a CED.

FIG. 6 illustrates a flow chart showing a method of operating a CED.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed. In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular, a base station (BS), of the RAN, and the one or more receiver nodes can be implemented by terminals (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios, e.g., uplink (UL) communication and/or sidelink communication.

### Communication Via CEDs

According to various examples, the transmitter node can communicate with at least one of the receiver nodes via one or more CEDs.

The CEDs may include an antenna array. The CEDs may include a meta-material surface. In examples, the CEDs may include a reflective antenna array (RAA).

There are many schools-of-thought for how CEDs should be integrated into 3GPP-standardized RANs.

In an exemplary case, the NW operator has deployed the CEDs and is, therefore, in full control of the CEDs' operations. The UEs, on the other hand, may not be aware of the presence of any CED, at least initially, i.e., it is transparent to a UE whether it communicates directly with the AN or via the CEDs. The CEDs essentially function as a coverage-extender of the AN. The AN may have established control links with the CEDs.

According to another exemplary case, it might be a private user or some public entity that deploys the CEDs. Further, it may be that the UE, in this case, controls the CEDs' operations. The AN, on the other hand, may not be aware of the presence of any CED and, moreover, may not have control over it/them whatsoever. The UE may gain awareness of the presence of a CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED. It is also possible that the UE gains awareness of the presence of a CED using UWD (Ultra wideband) communication. Using UWB may offer better time resolution due to the wider bandwidth compared to other radio technologies.

The two exemplary cases described above are summarized in TAB. 1 below.

TABLE 1
Scenarios for CED integration into cellular NW

| Scenario | Description | Explanation |
|---|---|---|
| A | AN-CED | AN controls the CED and/or can obtain |
| | control link | information from the CED. A control link is |
| | | established between the AN and the CED. |
| B | UE-CED | UE controls the CED and/or can obtain |
| | control link | information from the CED. A control link is |
| | | established between the UE and the CED. |

Hereinafter, techniques will be described which facilitate communication between a transmitter node—e.g., an AN—and one or more receiver nodes—e.g., one or more UEs—using a CED.

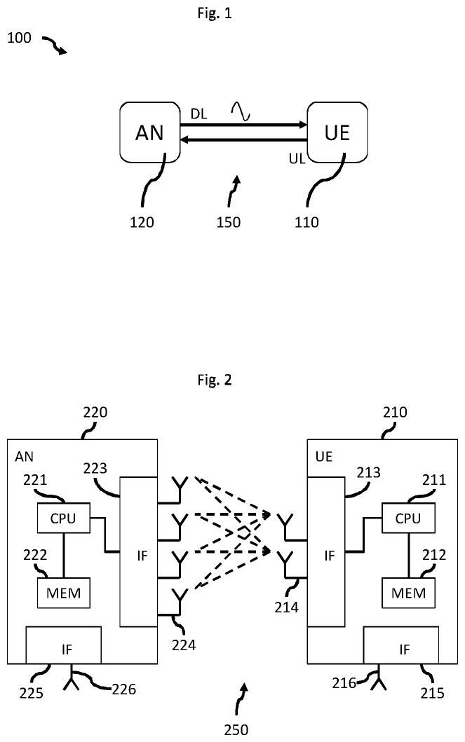

FIG. 1 schematically illustrates a communication system 100. The communication system 100 includes two nodes 110, 120 that are configured to communicate with each other via a radio channel 150. In the example of FIG. 1, the node 120 is implemented by an access node (AN) and the node 110 is implemented by a UE. The AN 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by an AN 120 of a cellular NW and a UE 110.

As illustrated in FIG. 1, there can be DL communication, as well as UL communication. Some examples described herein focus on the DL communication, but similar techniques may be applied to UL communication and/or sidelink communication. FIG. 2 illustrates details with respect to the AN 220. The AN 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the AN 220 and the UE 210 on the radio channel 250. The AN 220 includes an interface 223 that can access and control multiple antennas 224. Likewise, the UE 210 includes an interface 213 that can access and control multiple antennas 214.

The UE 210 comprises a further interface 215 that can access and control at least one antenna 216 to transmit or receive a signal on an auxiliary radio channel different from the radio channel 250. Likewise, the AN 220 may comprise an additional interface 225 that can access and control at least one antenna 226 to transmit or receive a signal on the or a further auxiliary radio channel different from the radio channel. In general, the interface 225 may also be a wired interface. It may also be possible that the interface 225 is a wired or wireless optical interface. If wireless, the auxiliary radio channel may use in-band signaling or out-of-band signaling. The radio channel and the auxiliary radio channel may be offset in frequency. The auxiliary radio channel may be at least one of a Bluetooth radio channel, a WiFi channel, or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the AN 220, as a general rule, it would be possible to employ transmit-receive points (TRPs) that are spaced apart from the AN 220.

The interfaces 213, 223 can each include one or more transmitter (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the AN 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Energy may also be focused to a specific point (or limited volume) at a specific direction and a specific distance of the transmitter. Thereby, a data stream may be directed in multiple spatial directions and/or to multiple specific points. The data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

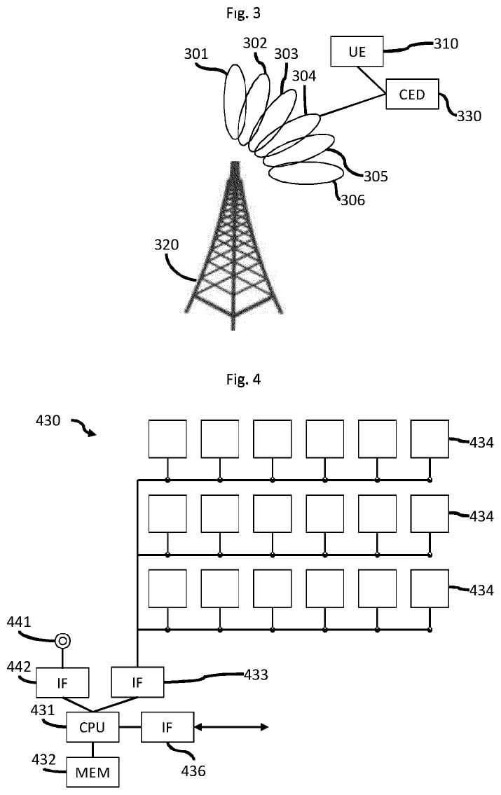

FIG. 3 illustrates DL TX beams 301-306 used by the AN 320. Here, the AN 320 activates the beams 301-306 on different resources (e.g., different time-frequency resources, and/or using orthogonal codes/precoding) such that the UE 310 can monitor for respective signals transmitted on the DL TX beams 301-306.

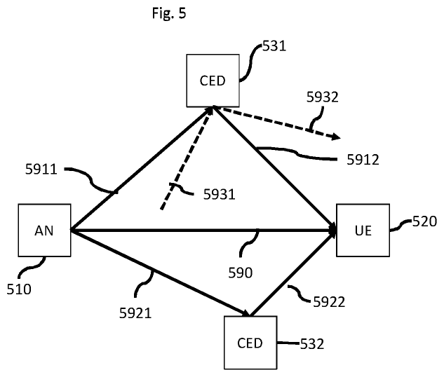

It is possible that the AN 320 transmits signals to the UE 310 via a CED 330. In the scenario of FIG. 3, the downlink transmit beam 304 is directed towards the CED 330. Thus, whenever the AN 320 transmits signals to the UE 310 using the downlink transmit beam 304—e.g., a respective block of a burst transmission—, a spatial filter is provided by the CED 330. The spatial filter is associated with a respective spatial direction into which the incident signals are then selectively reflected by the CED 330. Details with respect to the CED 330 are illustrated in connection with FIG. 4.

FIG. 4 illustrates aspects in connection with the CED 430. The CED 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The CED 430 thus provides coverage extension by reflection of radio-frequency (RF) signals. A translation to the baseband may not be required. This is different to, e.g., decode-and-forward repeaters or regenerative functionality. The antennas 434 may induce an amplitude shift by attenuation. In some examples, the antennas 434 may provide forward amplification with or without translation of signals transmitted on the radio channel to the baseband. In some examples, the CEDs may be configurable to shift power from one polarization to the orthogonal polarization. The antennas 434 may amplify and forward the signals.

The CED 430 includes an antenna interface 433, which controls an array of antennas 434; a processor 431 can activate respective spatial filters one after another. The CED 430 further includes an interface 436 for receiving and/or transmitting signals on an auxiliary radio channel. The interface 436 may be a wireless interface. In some examples, the auxiliary radio channel may be replaced with a wired auxiliary channel and the interface 436 may be a wired interface. There is a memory 432 and the processor 431 can load program code from the non-volatile memory and execute the program code. Executing the program code causes the processor to perform techniques as described herein.

FIG. 4 is only one example implementation of a CED. Other implementations are conceivable. For example, a meta-material surface not including distinct antenna elements may be used. The meta-material can have a configurable refraction index. To provide a reconfigurable refraction index, the meta-material may be made of repetitive tunable structures that have extensions smaller than the wavelength of the incident RF signals.

### Partially Autonomous Coverage Enhancing Devices (CEDs)

The provision of the control links required for scenarios A and B described with respect to TAB. 1 may be difficult. For example, CEDs may be employed in geographical locations which may not allow for a wired connection between the AN and the CED. In some scenarios, few time/frequency resources may be available for controlling the CED via a wireless connection. The difficulties may become even more severe with an increasing number of CEDs. Thus, there may be a need for reducing the overhead for controlling the CED.

FIG. 5 illustrates a scenario with an AN 510, a UE 520 and one or more CEDs 531, 532. In the illustrated scenario, the AN 510 is to transmit signals on a radio channel to the UE 520. As shown in FIG. 5, there may be a direct propagation path 590 between the AN 510 and the UE 520 as well as two indirect propagation paths 5911, 5912 and 5921, 5922. The CEDs 531, 532 may establish the indirect propagation paths 5911, 5912 and 5921, 5922, respectively.

The CED 531 may provide reconfigurable filters for incident signals received along one or more input spatial directions on a radio channel and transmitted as outgoing signals into one or more output spatial directions.

For example, a first filter provided by the CED 531 may allow for receiving incident signals along an input spatial direction corresponding to the propagation path section 5911 and transmitting said signal as outgoing signal in an output spatial direction corresponding to the propagation path part section 5912. Another filter provided by the CED 531 may allow for receiving incident signal along the input spatial direction 5931 and transmitted as outgoing signals into output spatial direction 5932.

Inventors found that an AN 510 that learns the radio channel and adapts transmission to it will almost only transmit signals (partially) in a direction to the CED 531 in case the CED 531 applies the first filter and establishes the propagation path 5911, 5912. Thus, the CED 531 will only receive power on the radio channel in case the first filter is applied by the CED 531. In case the CED 531 applies the filter corresponding to directions 5931, 5932, the AN 510 may not transmit (or transmit significantly less) power to the CED 531, because the directions 5931, 5932 do not correspond to a propagation path from the AN 510 to the UE 520. Hence, the amount of power that reaches the CED 531 on the radio channel when applying a specific filter may allow the CED 531 to determine whether the CED 531 actually establishes propagation paths useful for the transmission of signals between two communication nodes.

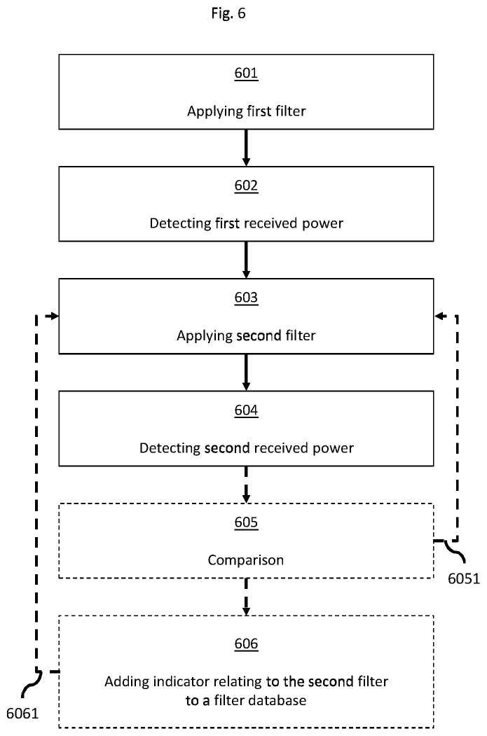

Thus, examples described herein may implement a method as described with respect to FIG. 6. At 601, the CED 531 is configured to apply a first filter of reconfigurable filters for incident signals received along one or more input spatial directions on a radio channel and transmitted as outgoing signals into one or more output spatial directions.

The reconfigurable filters may comprise at least one of a spatial filter, a bandpass frequency filter, a bandstop frequency filter, a lowpass frequency filter, a highpass frequency filter, and a distance filter. In examples, the reconfigurable filters may provide an additional propagation path from one CN to another CN. A distance filter may allow the CED to focus incoming signal to a specific volume at a certain location to improve communication between a CN in said volume and another CN. This may be particularly advantageous if a CN with a comparably small effective antenna is close to a CED with a comparably large effective antenna.

CNs may regularly determine an optimized beam configuration for communication on a radio channel. Said procedure may be called a beam sweep. An optimized beam configuration resulting from the beam sweep may then be applied by the CNs and be used for exchanging data between the CNs. The beam sweep may be regularly, or after a certain time, repeated to find a new optimized beam configuration. The beam sweeps may be repeated at a certain repetition rate. The duration during which the first filter is applied may be advantageously aligned and synchronized with repetition rate.

The first filter may be applied for a duration longer than of at least one of: 20 ms, 25 ms, 30 ms, 35 ms, 40 ms, 45 ms, 50 ms, 55 ms, 60 ms, 65 ms, 70 ms, 80 ms, 90 ms, 100 ms, 150 ms, 200 ms, 250 ms, 300 ms, 350 ms, 400 ms, 450 ms, 500 ms, 600 ms, 700 ms, 800 ms, 900 ms, 1 s, 2 s, 3 s, 4 s, 5 s, 10 s, 20 s, 1 min, 2 min, 3 min, 5 min, 10 min, 20 min, 30 min, 1 h, 2 h, 3 h, 6 h, 12 h, 24 h, 2 days, 3 days, 7 days. 8 days, 14 days.

The different durations noted above may each have respective advantages associated with them. For example, in 3GPP technical standards, 20 ms is the minimum SSB beam sweep rate.

The first filter may be applied for a duration greater or equal than 20 ms. The first filter may be applied for a duration of at least 21 ms, in particular of at least 41 ms, more particularly of at least 81 ms. In examples, the first filter may be applied for a duration of at least 101 ms, in particular of at least 201 ms, more particularly of more than 1 second. The duration during which the first filter is applied may also be longer than 11 seconds, in particular longer than 22 seconds, more particularly longer than 61 seconds. The duration during which the first filter is applied may in some examples even be longer than one minute, in particular longer than two minutes, more particularly longer than 31 minutes. The duration during which the first filter is applied may depend on the number of filters the CED may apply. Using a duration greater than or equal to 20 ms may have the advantage that the first filter is applied long enough to be usable by a CN during a beam sweep as specified by 3GPP TS 38.213 V16.7.0. In some examples, the repetition rate may correspond to a repetition rate of a Synchronization Signal Block (SSB) beam sweep. Using a duration equal to or greater than e.g. 100 ms may have the advantage that the first filter is applied long enough to be usable by a CN during a beam sweep (a.k.a. beacon interval) as specified by IEEE 802.11 ad. In examples, the duration during which the first filter is applied may correspond to at least two times, in particular more than ten times, a beam sweep repetition rate specified for CNs communicating via the CED. This may avoid the need for synchronizing the application of the first filter with beam sweep performed by the CNs. In particular, the duration during which the first filter is applied will always comprise at least one complete beam sweep performed by the CNs. In some examples, the repetition rate of an SSB beam sweep and/or a beacon interval may be configured by the network. Using a longer duration during which the first filter is applied may allow for implementing the method of operating the CED free of knowledge concerning an SSB beam sweep and/or beacon interval configuration of the network.

Durations above 1 seconds may be advantageous to avoid that comparably short term environmental changes (e.g., a car passing through the line-of-sight between a CED and an AN/a UE) lead to a wrong conclusion concerning the general usefulness of the first filter. Durations above 12 h may allow for detecting filters which are useful only during a certain time of the day. For example, a specific filter may only be useful when a user and the UE are in the canteen for lunch. If the first filter is applied for less than a few hours, the CED may not be able to find out that first filter is useful during lunch time. Durations above 3 days may be useful to take into account changes in user activity during a week. For example, some filters may be useful during work days where other filter may have advantages at weekends.

In examples, the first received power may be detected using at least one of the first antenna elements used by the CED 531 for providing the reconfigurable filters for incident signals along one or more spatial directions on a radio channel and transmitting the incident signal into one or more output spatial directions.

Other examples may prescribe that the CED 531 comprises at least one second antenna element adapted for measuring the received power. The CED 531 may comprise at least one dedicated second antenna element for measuring the received power. For example, the first antenna elements of the CED 531 may correspond to antennas 434 shown in FIG. 4 and the second antenna element may correspond to the antenna 441 connected via interface 442 to the CPU 431.

The first received power may be detected omnidirectionally.

At 603, the CED 531 is configured to apply a second filter of the reconfigurable filters. During application of the second filter, the CED 531 detects 604 a second received power.

Like the first received power, the second received power may be detected using the first antenna elements or second antenna elements.

At 605, a comparison of the detected second received power with a predefined criterion and/or the first received power is performed.

Depending on a result of the comparison, an indicator relating to the second filter is added 606 to a filter database.

As indicated with arrows 6051, 6061, actions 603 to 605 or 603 to 606 may be repeated. At every new iteration of 603, the applied second filter may be a new second filter and any one of the former second filters may be considered as first filter at box 605.

In some examples, the indicator may be indicative of at least one of the one or more input spatial directions and/or the one or more output spatial directions. For example, the CED may determine that it regularly receives power for different filters, when the different filters relate to the same input spatial direction but different output spatial directions. This may be the case if the relative position between the CED and an AN transmitting signals does not change. In this case, the CED may determine that it is useful to keep the input spatial direction constant and enter an indicator corresponding to the input spatial direction of the second filter to the filter database. This may be determined by performing a comparison of at least a first indicator and a second indicator of the filter database and adding a third indicator to the filter database depending on a result of the comparison. In some examples, reciprocity may apply. There may not be any differentiation between an input spatial direction and an output spatial direction. The indicator may be indicative of an angle-pair and/or spatial direction-pair.

In some examples, one of the input (or output) spatial directions may be predefined and the CED only toggles through different output (or input) spatial directions and determines the respective received power. In this case, the indicator may only relate to the respective output (or input) spatial direction.

The filter database may be preconfigured. For example, the filter database may be preconfigured with at least one predefined input and/or output spatial direction. For example, if the relative position between the CED and one of the CNs involved in exchanging data is fixed, the filter database may be preconfigured with input and/or output spatial directions corresponding to the relative position.

Additionally the indicator mentioned before may be indicative of at least one of the detected second received power, a time of detection of the second received power, a duration of the second received power, an average of the second received power, and an accumulated energy. The detected second received power may allow to determine how much the additional propagation path established by the CED is used for exchanging data at a certain point in time in comparison to other propagation paths. A time of detection of the second received power may allow for an analysis at which point in time the additional propagation path is actually used. For example, the propagation path established by a certain filter of a CED may only be used in the evening when a user is operating his UE at home. Vice versa, another propagation path may only be used during working hours when a milling machine connected to the internet is operating. The duration of the second received power may allow be used to decide which filter the CED should later use. For example, using a filter corresponding to a longer duration may be more useful than using a filter corresponding to a short duration with respect to a more optimal usage of time/frequency resources.

The first filter and the second filter may be selected randomly. This may often allow for determining an optimized filter faster in case the CED is deployed at a random location.

In examples, the second filter may be selected depending on the first filter. In examples, there may be a deterministic algorithm for determining the second filter to be applied by the CED. The second filter may also be determined by a plurality of filters previously applied. Some examples, may prescribe that the second filter is selected depending on the first received power. For example, the first received power may be close to zero. Then, a second filter may be selected corresponding to input/output spatial directions being very different from the input/output spatial directions associated with the first filter. In some examples, the second filter may be selected depending on a current content of the filter database. The filter database may be constantly updated.

CEDs as described hereinbefore may be produced in large quantities at comparably low cost. This opens up the possibility to deploy a massive number of these CEDs in an environment; possibly counted in hundreds per AN. Letting an AN or a UE control each CED may now be easier said than done—due to the sheer number of CEDs and the ensuing overhead. On the other hand, such future is appealing as a large number of CEDs would allow for far superior performance compared with only a few CEDs per AN.

At least partially autonomous CEDs as described hereinbefore may allow for reducing or dispensing with controlling the CEDs by the ANs and/or UEs.

In many future use cases, at least some of the following assumptions may apply. At least the AN of the communication system is using beamforming. In particular, the communication system may operate in a frequency band where at least the AN is using beamforming. The CED may be relatively cheap due to future mass production. The CED may be capable of reflecting impinging electro-magnetic signals to a dedicated point/volume (near-field) or direction (far-field). This may correspond to a CED providing reconfigurable filters for incident signals received along one or more input spatial directions on a radio channel and transmitted as outgoing signals into one or more output spatial directions as described hereinbefore. The quantized beam pairs (a beam pair comprise an input direction and an output direction) formed by the impinging direction precoders and reflection direction precoders, which may also be considered as filters, may be saved in a codebook, which may be considered a database.

The CED is equipped with a detector for detecting a received power, in particular a received power at a certain frequency or frequency range. The power detector of the CED may be equipped with a separate antenna that may have a spherical coverage corresponding to at least the beam directions specified in a codebook of the CED. In other words, the radiation pattern of the power detector antenna may essentially overlap with the beam pairs of the CED codebook.

In some embodiments the detector antenna may be non-omni directional and directed toward a fix CN, e.g., a gNB. This could potentially be beneficial at lower frequencies, e.g. sub 6 GHz, when UEs typically are not capable of beam forming.

The advantages of a plurality of at least partially autonomous CEDs may be best understood by first focusing on the behaviour of a single at least partially autonomous CED. As mentioned above, the CED may comprise a codebook of beam pairs. The CED chooses (e.g. randomly) a beam pair. This means that a new propagation path is created in the environment. If this propagation path is useful for the communication system as a whole, then the AN or the UE will start to utilize this new propagation path, and, thus, direct signals towards the CED. For example, once the new propagation path is established, it may be identified by the AN or UE during an SSB beam sweep and subsequently used for ongoing communication between the AN and the UE. The CED, which has a power detector, observes that there is incoming power. If the random beam pair is not a meaningful one, e.g., it reflects (non-existing) signals from a point under a bed to a nearby plant, then the AN will not use such propagation path. Thus, the power detector will not observe any impinging power.

If the CED is observing a received power above a predefined threshold for a duration that exceeds another predefined threshold (e.g., a day or week), then the CED may keep the current beam pair indefinitely. Henceforth, a currently indefinitely configured beam pair may be called a serving beam pair. As a somewhat more advanced learning feature, a CED may be (self-)configured with several serving beam pairs visited in a time-division duplex (TDD) fashion. On the other hand, if the CED is not observing any received power (i.e., impinging power) for a newly configured beam pair during, e.g., the first hour, then the CED may determine that this propagation path is not useful for the communication system. The CED may consequently try another one, i.e. another one of the reconfigurable filters.

The CED may also try another filter if it stops observing any impinging power for the serving beam pair for an extent of time given by another threshold value. In fact, the CED may periodically, or regularly, step away from a serving beam pair and try another beam pair, i.e., a training beam pair, for some amount of time. By properly balancing the amount of serving and training time, the CED may guarantee a certain quality of service to the devices being served while, at the same time, being able to learn changes in the environment, e.g., due to blockage by operators or moving devices.

For example, when a CED is newly deployed, it mostly or entirely configures training beam pairs in order to discover a subset of useful beam pairs from the codebook; later on, when/if one or more serving beam pairs have been discovered, a more significant part of the time can be spent to serve the devices in the environment, and only a small amount of training time is needed to keep up with changes in the environment.

Different methods of operating a CED may evaluate a current beam pair differently. A method of operating a CED may apply machine learning for evaluating beam pairs.

A CED placed randomly in the environment will in many cases not be able to provide a filter leading to a meaningful beam pair. The CED placed randomly may not be able to establish a useful additional propagation path. Therefore, the CED may have to be collected and placed at another location. However, mass produced CEDs may be so cheap that 100 of them may deployed at a certain point in time and a week later the 80 CEDs that are the least meaningful are collected to be redeployed elsewhere.

Thus, there may be a need for extracting information on the usefulness of an individual CED for the communication system from the individual CED. In the most simple case, this information can be displayed on a display of the CED. In some examples, the information may also be obtained via Bluetooth or near field communication. It may also be possible to retrieve the information by connecting a cable, e.g. a USB cable to the CED. Other examples may prescribe that the information is exchanged between wireless or wired connected CEDs. The information so obtained or instructions given may include an average of the received power (e.g., an hourly average impinging power per day of the week), a time of detection of the received power, an indicator indicative of the applied filter (e.g., beam pair index) for which the previous data is measured.

If there are many used beam pairs, then information may be provided per beam pair. For example, the CED could observe that late at night it should direct signals towards the bedroom, and early in the morning towards the kitchen table, etc. The CED may also detect that there is at least one common beam for all meaningful beam pairs (i.e. found an AN).

The information may include temporal information associated with the data mentioned above. By analyzing the temporal information collected by one or more CEDs, an operator may figure out spatio-temporal correlations among the CEDs. For example, an operator may discover that a certain UE or group of UEs is simultaneously served by up to two CEDs, but never by three or more, and so the RIS deployment density may be reduced in some areas.

A double-directional heat-map indicating the average power of the incoming and reflecting directions associated with the beam pairs in the CED codebook may be derived from the information provided by the CEDs.

Furthermore, a pattern for serving and/or training beam pairs configured by the CED may be obtained. In some examples, the CED may be preconfigured with respect to a time in which training beam pairs should be applied and a time in which serving beam pairs should be applied. Further examples may provide for means for automatically and/or manually resetting the CED algorithm (e.g. if the CED is moved, environment has changed etc.).

A method of operating a CED as described herein may apply reinforcement learning techniques. Reinforcement learning (RL) is an area of machine learning (ML) dealing with how agents in an environment ought to take actions so as to maximize a certain measure of reward. Through its actions, the agent can affect, i.e., modify, the environment.

A CED may be considered as an agent, a state may correspond to a selected/configured beam pair, an action may refer to a modification of the radio environment by enabling certain propagation paths through a configured beam pair, the reward may be associated with measured average power and the radio environment may correspond to the scenario in which the CED, AN(s) and UE(s) are deployed.

A CED may try a particular filter corresponding to a beam pair configuration, and then wait for a pre-defined/configurable amount of time while carrying out measurements with the power detector. If a beam pair configuration is suitable for establishing a useful propagation path, an AN-UE pair may start conducting measurements, e.g., RSSI measurements, over this newly created propagation path relatively often, i.e., exceeding a certain frequency of measurements. If more time is assigned to this configuration, probably even more RSSI measurements will happen (up to a point). The CED learns this is a good beam pair configuration and assigns a relatively large weight to it. Based on the assigned weights, one or more serving beam pairs may be selected by the CED.

It may appear as if many CEDs that randomly try beam pairs could lead to an interference situation that is out of control. However, since there is beamforming at least at the AN, the AN would simply not use propagation paths that cause interference at, e.g., nearby ANs.

Contrary to methods of operating CEDs, which prescribe that the CED is essentially tracking a UE, partially autonomous CEDs as described herein may operate differently. Rather than using a single (or a few) CEDs to track a UE, many CEDs tune themselves to reflect in directions where UEs tend to be located during a substantial amount of time during the day/week (e.g. in an industrial deployment, coffee shop etc.).

In some embodiments dynamic configurations, capable of tracking repetitive CN trajectories, could be implemented.

Accordingly, an overhead for controlling the CED may be substantially reduced.

1. A method of operating a coverage enhancing device (CED) wherein the CED provides reconfigurable filters for incident signals received along one or more input spatial directions on a radio channel and transmitted as outgoing signals into one or more output spatial directions, the method comprising:
configuring the CED to apply a first filter of the reconfigurable filters for a duration greater than or equal to 20 ms;
detecting a first received power during application of the first filter; and
configuring the CED to apply a second filter of the reconfigurable filters for a duration greater than or equal to 20 ms.

2. A method of operating a coverage enhancing device (CED) in particular the method according to claim 1, wherein the CED provides reconfigurable filters for incident signals received along one or more input spatial directions on a radio channel and transmitted as outgoing signals into one or more output spatial directions, the method comprising:
configuring the CED to apply a first spatial filter of the reconfigurable filters;
detecting a first received power during application of the first filter;
configuring the CED to apply a second filter of the reconfigurable filters, and
detecting a second received power during application of the second filter; and
performing a comparison of the detected second received power with a predefined criterion and/or the first received power,
depending on a result of the comparison:
adding an indicator relating to the second filter to a filter database.

3. The method of operating the CED of claim 2, wherein the indicator is indicative of at least one of the one or more input spatial directions and/or the one or more output spatial directions.

4. The method of operating the CED of claim 2, further comprising,
performing a comparison of at least a first indicator and a second indicator of the filter database,
adding a third indicator to the filter database depending on a result of the comparison.

5. The method of operating the CED of claim 2, wherein the filter database is preconfigured.

6. The method of operating the CED of claim 2, wherein the indicator is indicative of at least one of
the detected second received power;
a time of detection of the second received power;
a duration of the second received power,
an average of the second received power, and
an accumulated energy.

7. The method of operating the CED of claim 1, wherein the first filter and the second filter are selected randomly.

8. The method of operating the CED of claim 1, wherein the second filter is selected depending on the first filter.

9. The method of operating the CED of claim 8, wherein the second filter is selected depending on the first received power.

10. The method of operating the CED of claim 2, further comprising providing a message indicative of at least one indicator in the filter database, in particular to a further CED.

11. The method of operating the CED of claim 2, further comprising obtaining a message indicative of at least one indicator in a filter database from a or the further CED.

12. The method of operating the CED of claim 1, wherein the first filter and/or the second filter are selected from a list of predefined filters.

13. The method of operating the CED of claim 1, wherein the reconfigurable filters comprise at least one of:
a spatial filter;
a bandpass frequency filter,
a bandstop frequency filter,
a lowpass frequency filter,
a highpass frequency filter,
a distance filter.

14. A coverage enhancing device (CED) comprising:
first antenna elements providing reconfigurable filters adapted for receiving incident signals along one or more spatial directions on a radio channel and transmitting the incident signals into one or more output spatial directions; and
a detector for detecting a received power upon application of at least one of the filters.

15. The CED of claim 14, further comprising;
control circuitry configured for performing the method of claim 1.

16. The CED of claim 14, wherein the detector comprises at least one second antenna element adapted for measuring the received power.

17. The CED of claim 14, wherein the detector is configured for detecting the received power via at least one of the first antenna elements.
